(19) United States
(12) Patent Application Publication
(10) Pub. No.: US 2005/0119890 A1
(43) Pub. Date: Jun. 2, 2005

(54) Speech synthesis apparatus and speech synthesis method

(76) Inventor: Yoshifumi Hirose, Soraku-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/998,035

(22) Filed: Nov. 29, 2004

(30) Foreign Application Priority Data
Nov. 28, 2003 (JP) 2003-399595

(51) Int. Cl. G10L 13/08

(52) U.S. Cl. 704/260

(57) ABSTRACT

The present invention includes: a characteristic parameter DB 106 that holds, with respect to each speech-unit, speech-unit data indicating a loan word attribute and acoustic characteristics; a language analysis unit 104 and a prosody prediction unit 109 that obtain text data and respectively predict a loan word attribute and acoustic characteristics of each of a plurality of speech-units that form text indicated by the text data; a speech-unit selection unit 108 that selects, from the characteristic parameter DB 106, speech-unit data that represents the loan word attribute and the acoustic characteristics similar to the predicted loan word attribute and acoustic characteristics of each speech-unit; and a speech synthesis unit 110 that generates synthesized speech using a plurality of the selected speech-units and outputs the synthesized speech.

### BACKGROUND OF THE INVENTION

(1) Field of the Invention

The present invention relates to a speech synthesis apparatus that converts a given character string (text) into speech and a speech synthesis method therefor.

(2) Description of the Related Art

A conventional speech synthesis apparatus selects a sequence of phonetic segments from a phonetic segment database according to a minimum cost criterion that uses a cost function calculated based on acoustic characteristics, and generates synthesized speech using the selected sequence of phonetic segments (See, for example, Japanese Patent Publication No. 3050832).

FIG. 1 is a block diagram showing a structure of the above-mentioned conventional speech synthesis apparatus.

A speech analysis unit 10 labels speech data stored in a speech waveform database 21 using a text database 22 and a phoneme HMM (hidden Markov model) 23, and extracts acoustic characteristics from each phoneme (each phonetic segment). Here, acoustic characteristics are, for example, fundamental frequencies, powers, durations, cepstrum coefficients which are derived based on cepstrum analyses, and the like. The information indicating each of the extracted acoustic characteristics is stored, as a phonetic segment, into a characteristic parameter 30 that is the above phonetic segment database. A speech-unit selection unit 12 searches for the phonetic segment which is closest acoustically to a target phonetic segment by referring to the characteristic parameter 30 that holds the information indicating the acoustic characteristics. If there are a plurality of target phonetic segments, a plurality of phonetic segments are searched as a sequence of phonetic segments. Here, the speech-unit selection unit 12 selects the sequence of phonetic segments in consideration of the deviations between the target phonetic segments and the extracted fundamental frequencies, powers and durations, as well as the distortion created when the phonetic segments are concatenated. A speech synthesis unit 13 obtains, from the speech waveform database 21, a plurality of speech data that correspond to the sequence of phonetic segments selected by the speech-unit selection unit 12, and concatenates them so as to generate synthesized speech.

However, the above-mentioned conventional speech synthesis apparatus has a problem that it outputs synthesized speech with unnatural accents, intonations or the like. In more detail, the conventional speech synthesis apparatus cannot select appropriate phonetic segments because it selects the phonetic segments based on their acoustic characteristics only, and as a result, unnatural synthesized speech is generated using such inappropriate phonetic segments. In addition, in the conventional speech synthesis apparatus, extraction of acoustic characteristics of a target phonetic segment has a serious impact on its selection of phonetic segments. Therefore, the conventional speech synthesis apparatus selects more inappropriate phonetic segments if it cannot extract the acoustic characteristics properly.

### SUMMARY OF THE INVENTION

The present invention has been conceived in view of the above problems, and an object of the present invention is to provide a speech synthesis apparatus that is capable of outputting natural synthesized speech and a speech synthesis method therefor.

In order to achieve the above object, the speech synthesis apparatus according to the present invention is a speech synthesis apparatus that obtains text data and converts text indicated by the text data into speech, comprising: a storage unit operable to previously store, with respect to each speech-unit, speech-unit data that represents (i) a loan word attribute indicating whether or not a speech-unit belongs to a class of loan words and (ii) an acoustic characteristic of the speech-unit; a characteristic prediction unit operable to obtain text data and predict, with respect to each of a plurality of speech-units that form text indicated by the text data, a loan word attribute and an acoustic characteristic; a selection unit operable to select speech-unit data that represents a loan word attribute and an acoustic characteristic similar to the loan word attribute and the acoustic characteristic of each speech-unit predicted by the characteristic prediction unit, from among the speech-unit data stored in the storage unit; and a speech output unit operable to generate synthesized speech using a plurality of the speech-unit data selected by the selection unit and output the synthesized speech.

For example, when the characteristic prediction unit predicts the loan word attribute indicating that a speech-unit belongs to the class of loan words, the selection unit preferentially selects speech-unit data that represents the loan word attribute indicating that a speech-unit belongs to the class of loan words.

According to this configuration, when a speech-unit of text data belongs to a class of loan words, speech-unit data indicating the loan word characteristic is selected for the speech-unit. Therefore, it becomes possible to generate and output natural synthesized speech as a loan word just in the way the text data indicates. In more detail, a conventional speech synthesis apparatus selects speech-unit data based on only the acoustic characteristics of a speech-unit in text even if the speech-unit belongs to a class of loan words, and thus outputs unnatural synthesized speech which does not resemble the pronunciation of the loan word. On the contrary, the speech synthesis apparatus according to the present invention can output natural synthesized speech just as the text data indicates.

Alternatively, it is also possible that the speech-unit data further represents a final particle attribute indicating whether or not the speech-unit belongs to a class of final particles, the characteristic prediction unit predicts, with respect to each of a plurality of speech-units that form the text indicated by the text data, the loan word attribute, the acoustic characteristic and a final particle attribute, and the selection unit selects speech-unit data that represents a loan word attribute, an acoustic characteristic and a final particle attribute similar to the loan word attribute, the acoustic characteristic and the final particle attribute of the speech-unit predicted by the characteristic prediction unit, from among the speech-unit data stored in the storage unit.

For example, when the characteristic prediction unit predicts the final particle attribute indicating that the speech-unit belongs to the class of final particles, the selection unit preferentially selects speech-unit data that represents the final particle attribute indicating that a speech-unit belongs to the class of final particles.

Accordingly, when a speech-unit in text data belong to a class of final particles, speech-unit data that expresses a questioning feeling or the like is selected for the final particle. Therefore, it becomes possible to generate and output synthesized speech that expresses such a questioning feeling or the like just as the text data indicates.

Alternatively, it is also possible that the selection unit includes: a first calculation unit operable to calculate a first sub-cost by quantitatively evaluating a similarity level between the loan word attribute of the speech-unit predicted by the characteristic prediction unit and the loan word attribute of the speech-unit data stored in the storage unit; a second calculation unit operable to calculate a second sub-cost by quantitatively evaluating a similarity level between the acoustic characteristic of the speech-unit predicted by the characteristic prediction unit and the acoustic characteristic of the speech-unit data stored in the storage unit; a cost calculation unit operable to calculate a cost using the first and second sub-costs calculated by the first and second calculation units; and a data selection unit operable to select speech-unit data from among the speech-unit data stored in the storage unit, based on the cost calculated by the cost calculation unit.

For example, the cost calculation unit calculates the cost by assigning weights to the first and second sub-costs calculated by the first and second calculation units and adding up the weighted first and second sub-costs.

According to this configuration, the weights are assigned to the first and second sub-costs respectively, and thus it becomes possible to adjust, depending on the assigned weights, the ratio of influence for the selection of speech-unit data, between the similarity level of the acoustic characteristic and the similarity level of the loan word attribute.

It is also possible that the above-mentioned speech synthesis apparatus further comprises a weight determination unit operable to specify a confidence level of the acoustic characteristic predicted by the characteristic prediction unit and determine the weights to be assigned to the first and second sub-costs depending on the confidence level, and the cost calculation unit assigns the weights determined by the weight determination unit to the first and second sub-costs.

For example, when the confidence level of the acoustic characteristic is low, the weight determination unit determines the weights to be assigned to the first and second sub-costs so that the similarity level between the loan word attributes is more influential in the selection of the speech-unit data by the data selection unit than the similarity level between the acoustic characteristics.

Accordingly, the weights to be assigned to the first and second sub-costs vary depending on the confidence level of the acoustic characteristic, and thus it becomes possible to change appropriately the ratio of influence for the selection of speech-unit data, between the similarity level of the acoustic character and the similarity level of the loan word attribute.

It is also possible that the selection unit further include a third calculation unit operable to calculate a concatenation cost by quantitatively evaluating an acoustic distortion that occurs when a plurality of speech-unit data stored in the storage unit are concatenated, and the cost calculation unit calculates the cost using the first and second sub-costs calculated by the first and second calculation units and the concatenation cost calculated by the third calculation unit.

Accordingly, it becomes possible to restrain acoustic distortion and output more natural synthesized speech.

Here, the data creation apparatus according to the present invention is a data creation apparatus that creates speech-unit data to be used for speech synthesis, comprising: a speech storage unit operable to store a speech waveform signal that represents speech in a waveform; a text storage unit operable to store text data indicating text that corresponds to the speech represented by the speech waveform signal; a language analysis unit operable to obtain text data from the text storage unit, divide text indicated by the text data into speech-units, and analyze a loan word attribute of each speech-unit indicating whether or not the speech-unit belongs to a class of loan words; an acoustic analysis unit operable to obtain a speech waveform signal from the speech storage unit, divide the speech represented by the speech waveform signal into speech-units, and analyze an acoustic characteristic of each speech-unit; and a creation unit operable to create speech-unit data of each speech-unit so that said speech-unit data indicates the loan word attribute as analyzed by the language analysis unit and the acoustic characteristic as analyzed by the acoustic analysis unit, and store the created speech-unit data into a memory.

Accordingly, speech-unit data that represents a loan word attribute and an acoustic characteristic is stored for each speech-unit, and thus it becomes possible to select speech-unit data from the storage unit based on both the loan word attribute and the acoustic characteristic. In other words, it becomes possible to use the storage unit that stores the speech-unit data for the speech synthesis apparatus. As a result, by predicting a loan word attribute and an acoustic characteristic of each speech-unit in text indicated by text data and selecting speech-unit data that represents the similar loan word attribute and acoustic characteristic, the speech synthesis apparatus can generate natural synthesized speech just as the text data indicates.

Note that not only is it possible to embody the present invention as such a speech synthesis apparatus, but also as a method and a program for allowing the speech synthesis apparatus to synthesize speech and as a storage medium for storing the program.

As further information about technical background to this application, the disclosure of Japanese Patent Application No. 2003-399595 filed on Nov. 28, 2003 including specification, drawings and claims is incorporated herein by reference in its entirety.

### BRIEF DESCRIPTION OF THE DRAWINGS

These and other objects, advantages and characteristics of the invention will become apparent from the following description thereof taken in conjunction with the accompanying drawings that illustrate a specific embodiment of the invention. In the Drawings:

FIG. 1 is a block diagram showing a structure of a conventional speech synthesis apparatus;

FIG. 2 is a block diagram showing a structure of a speech synthesis apparatus in a first embodiment of the present invention;

FIG. 3 is a block diagram showing one example of an internal structure of a language analysis unit in the first embodiment of the present invention;

FIG. 4 is a diagram showing one example of contents of language information in the first embodiment of the present invention;

FIG. 5 is a diagram showing contents of acoustic characteristic information in the first embodiment of the present invention;

FIG. 6 is a diagram showing contents of linguistic characteristic information in the first embodiment of the present invention;

FIG. 7 is a diagram showing contents of one speech-unit data stored in a characteristic parameter database in the first embodiment of the present invention;

FIG. 8 is a block diagram showing one example of a specific structure of a speech-unit selection unit in the first embodiment of the present invention;

FIG. 9 is a diagram showing a target vector, a candidate and a target cost vector in the first embodiment of the present invention;

FIG. 10 is a diagram showing contents of language information generated from text data indicating a loan word in the first embodiment of the present invention;

FIG. 11A is an illustration for explaining a target phoneme for which speech-unit data is to be selected in the first embodiment of the present invention;

FIG. 11B is a diagram showing a target vector and candidates for the phoneme “u” in the first embodiment of the present invention;

FIG. 12A is an illustration for explaining a target phoneme for which speech-unit data is to be selected in the first embodiment of the present invention;

FIG. 12B is a diagram showing a target vector and candidates for the phoneme “e” in the first embodiment of the present invention;

FIG. 13A shows a result of analyzing a phone “ [symbol] ” in a Japanese adverb “ [symbol] <” (“fully” in English);

FIG. 13B shows a result of analyzing a phone “ [symbol] ” in a common noun “ [symbol] ” (“night” in English);

FIG. 13C shows a result of analyzing a phone “ [symbol] ” that is a Japanese postpositional particle included in one sentence;

FIG. 13D shows a result of analyzing a phone “ [symbol] ” that is a Japanese postpositional particle included in another sentence;

FIG. 14 is a block diagram showing a structure of a speech synthesis apparatus in a first modification of the first embodiment;

FIG. 15 is a block diagram showing an internal structure of a cost calculation unit in a second modification of the first embodiment;

FIG. 16 is a flowchart showing operations of speech-unit selection unit in a third modification of the first embodiment; and

FIG. 17 is a block diagram showing an overall structure of a data creation apparatus in a second embodiment of the present invention.

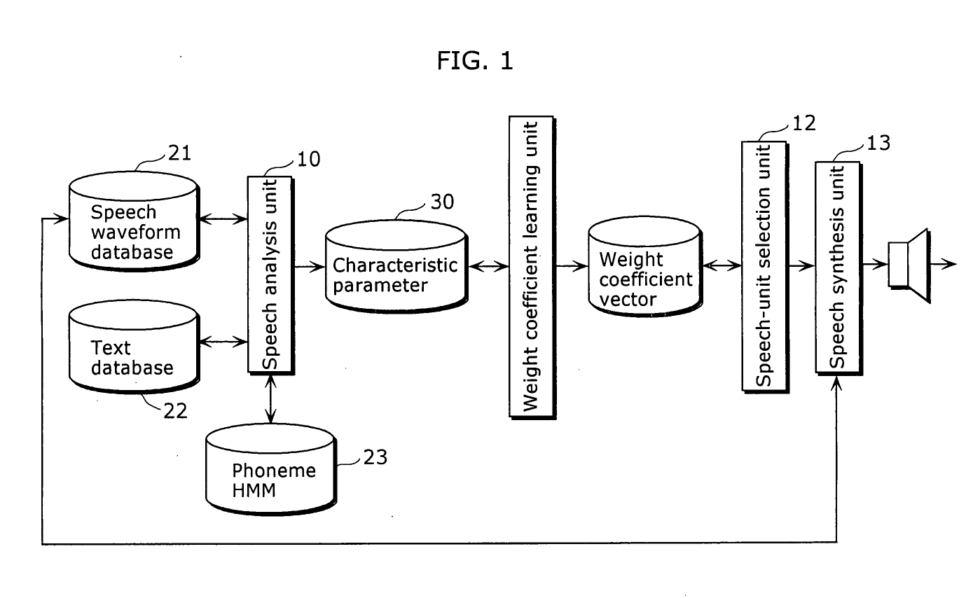

### DESCRIPTION OF THE PREFERRED EMBODIMENT(S)

### First Embodiment

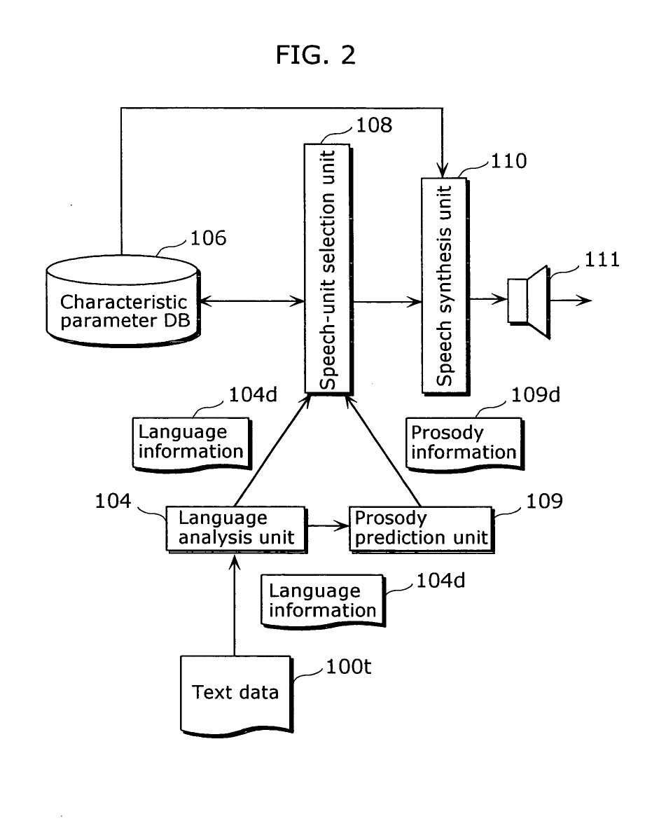

FIG. 2 is a block diagram showing a structure of a speech synthesis apparatus in the first embodiment of the present invention. This speech synthesis apparatus is a text-to-speech synthesis apparatus that converts inputted text into speech, and includes a characteristic parameter database (DB) 106, a language analysis unit 104, a prosody prediction unit 109, a speech-unit selection unit 108, a speech synthesis unit 110 and a speaker 111.

The characteristic parameter DB 106 is a database that holds speech-unit data indicating characteristics of a plurality of speech-units (Here, a speech-unit is a unit of speech or a speech segment). The language analysis unit 104 obtains text data 100t indicating text, extracts linguistic characteristics of the text from the text data 100t, and outputs the language information 104d indicating the linguistic characteristics.

The prosody prediction unit 109 predicts the prosody of the text based on the linguistic characteristics extracted by the language analysis unit 104, and generates prosody information 109d indicating the prediction result. The speech-unit selection unit 108 selects a sequence of speech-unit data which is most suitable f or the text, as a sequence of speech-units, from the characteristic parameter DB 106, based on the language information 104d and the prosody information 109d which are inputted from the language analysis unit 104 and the prosody prediction unit 109 respectively. Then, the speech-unit selection unit 108 notifies the speech synthesis unit 110 of the selected sequence of speech-units.

The speech synthesis unit 110 generates a speech waveform signal that represents, as a speech waveform, the characteristics (such as a formant and sound source information) of the speech-unit data selected by the speech-unit selection unit 108, based on such characteristics. Then, the speech synthesis unit 110 concatenates the speech waveform signals of respective speech-unit data included in the sequence of speech-units so as to generate a synthesized speech signal. The speaker 111 outputs the synthesized speech signal generated by the speech synthesis unit 110, as an audio wave (synthesized speech), to the outside.

Next, respective components of the speech synthesis apparatus shown in FIG. 2 are described in detail.

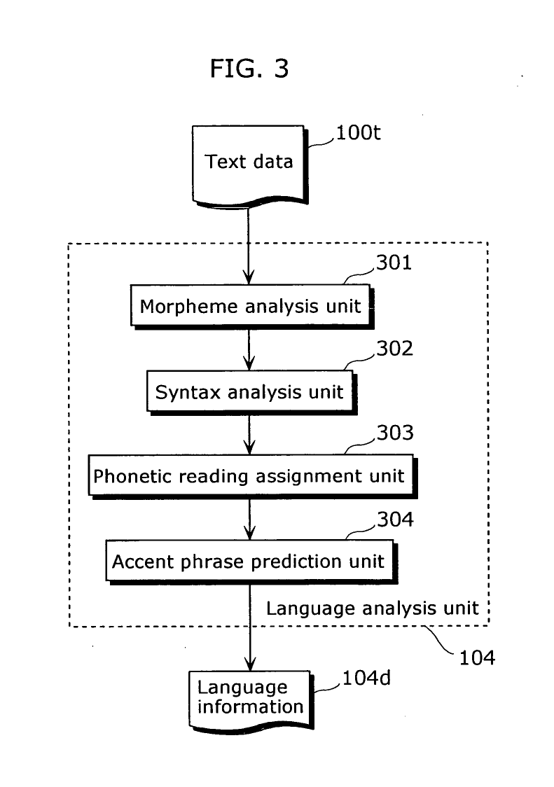

FIG. 3 is a block diagram showing one example of the internal structure of the language analysis unit 104.

The language analysis unit 104 includes a morpheme analysis unit 301, a syntax analysis unit 302, a phonetic reading assignment unit 303, and an accent phrase prediction unit 304.

The morpheme analysis unit 301 analyzes the morphemes of the text indicated by the text data 100t. The syntax analysis unit 302 analyzes the modification relation and the like between respective morphemes analyzed by the morpheme analysis unit 301. Such an analysis is hereinafter referred to as “syntax analysis”. When there are a plurality of phonetic readings for a morpheme analyzed by the morpheme analysis unit 301, the reading assignment unit 303 assigns a phonetic reading appropriate for the morpheme. The accent phrase prediction unit 304 performs processes such as accent phrase division and accent phrase concatenation for each morpheme analyzed by the morpheme analysis unit 301.

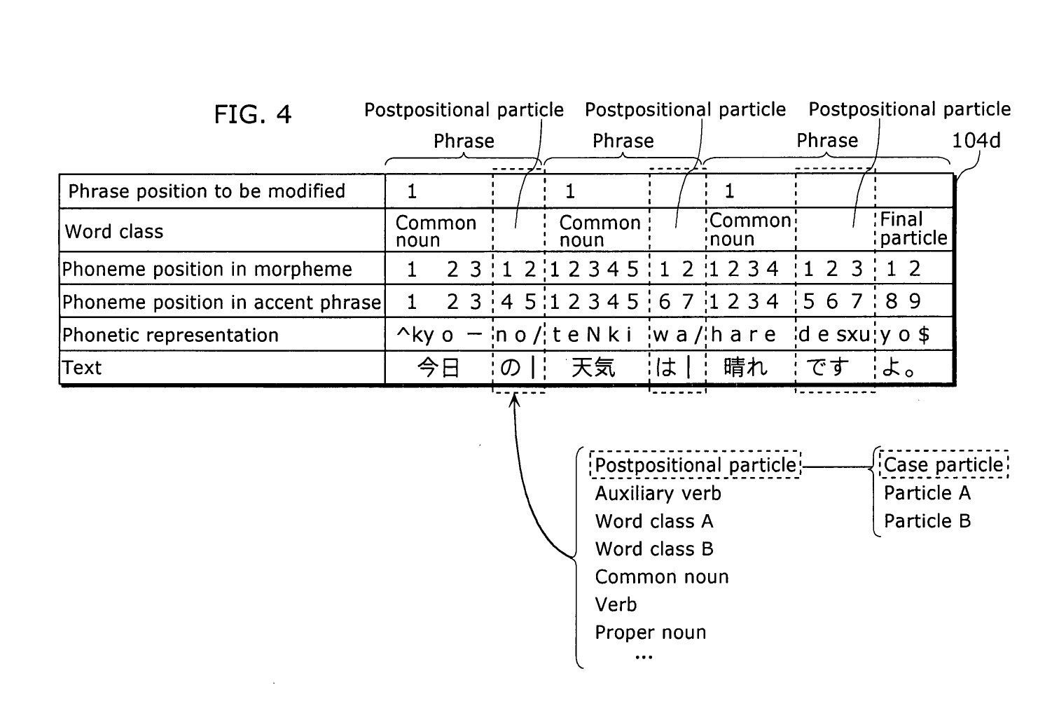

As mentioned above, upon obtaining the text data 100t, the language analysis unit 104 performs processes such as analyzing the morphemes and syntax and assigning appropriate phonetic readings, and outputs the language information 104d, for example, as shown in FIG. 4.

FIG. 4 is a diagram showing one example of the contents of the language information 104d.

The language information 104d outputted from the language analysis unit 104 indicates text, a sequence of phonemes corresponding to the text (phonetic representation), respective morphemes included in the text, respective phrases included in the text, word classes (word and particle classes, or their parts of speech) of respective morphemes, phoneme positions in each morpheme, phoneme positions in each accent phrase, and phrase positions to be modified. For example, text is “ [symbol] [symbol] [symbol] ” in Japanese (“it is fine today” in English). Respective morphemes are “ [symbol] ” (“today”), “ [symbol] ” (“of”) and others which are separated by vertical dashed lines in the text of FIG. 4. Respective phrases are “ [symbol] ”, “ [symbol] ” and “ [symbol] ” which are separated by vertical lines in the text of FIG. 4. The word classes of the morphemes “ [symbol] ” and “ [symbol] ” are a “common noun” and a “postpositional particle” respectively. Note that a category of postpositional particles is one of the word classes in Japanese, and indeclinable function words among the words which are always postpositioned to another word. A postpositional particle has a variety of functions of indicating a relation between a prepositioned word and another word, assigning a certain meaning such as a speaker's emotion, closing a sentence, and so on. The word class, in the context of the present embodiment, indicates not only an attribute of whether or not a morpheme is a loan word, but also an attribute of whether or not a morpheme is a final particle. Here, a category of final particles is a type of postpositional particles which is used at the end of a sentence or a phrase and indicates meanings of questioning, prohibition, admiration, impression and the like.

A phrase position to be modified indicates a phrase to be modified by each phrase. For example, the number “1” indicating the phrase position to be modified by the phrase “ [symbol] ” in FIG. 4 means that “ [symbol] ” modifies the immediately (namely, one) following phrase, namely, “ [symbol] ” The same applies to other phrases. The phoneme position in each morpheme indicates the position of each phoneme included in each morpheme, while the phoneme position in each accent phrase indicates the position of each phoneme included in each accent phrase.

Phonetic representation not only represents text by phonemes but also indicates an accent phrase and the beginning and the end of a sentence. For example, in FIG. 4, a phrase between slashes “/” in the phonetic representation is one accent phrase. The symbol “\hat{ }” indicates the beginning of the sentence, while the symbol “$” indicates the end of the sentence.

Note that it is also possible to show the word classes hierarchically in the language information 104d. For example, in the example shown in FIG. 4, the word class of the morpheme “ [symbol] ” is a “postpositional particle”, and particularly is a “case particle” that is one type of postpositional particles. Therefore, the language information 104d indicates “Postpositional particle” and “Case particle” as a word class of the morpheme “ [symbol] ”. Note that a case particle is one of the classes of postpositional particles in Japanese, and primarily indicates phrase/word relation between an indeclinable word and another word.

It is also possible to structure the language analysis unit 104 so as to predict a domain to which text belongs (such as sports, news and entertainment). For example, it is possible to preset, in the text data 100t, the information about the domain to which the text belongs, or extract keywords from the text for prediction of the domain.

Furthermore, it is also possible to structure the language analysis unit 104 so as to predict not only the domain but also the emotions such as delight, anger, sorrow and pleasure. For example, it is possible to preset, in the text data 100t, the information about the emotions which should be expressed in the text (“Voice XML” and the like are the standards feasible for this structure).

The prosody prediction unit 109 predicts the prosody which is most similar to the text indicated by the text data 100t, based on the language information 104d transmitted from the language analysis unit 104, and generates the prosody information 109d that is the prediction result. Here, the prosody information 109d indicates the duration, fundamental frequency and power per phoneme. Note that it is also possible to design the prosody prediction unit 109 so as to predict the duration, fundamental frequency and power not only per phoneme but also per mora or per phone. The prosody prediction unit 109 may make any type of prediction. For example, it may make a prediction using a well-known method of Quantification Type I.

Furthermore, although the prosody information 109d indicates the duration, fundamental frequency and power per phoneme here, it may indicate, in addition to them, the confidence level of the result of prosody prediction.

The characteristic parameter DB 106 stores a plurality of speech-unit data. This speech-unit data includes acoustic characteristic information indicating the acoustic characteristics of a speech-unit and the linguistic characteristic information indicating the linguistic characteristics thereof.

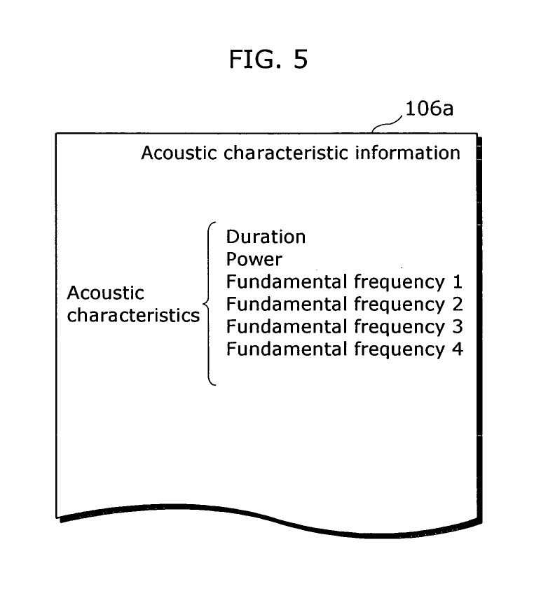

FIG. 5 is a diagram showing the contents of the acoustic characteristic information.

The acoustic characteristic information 106a indicates, as acoustic characteristics, at least a fundamental frequency, duration, power and the like, and it may further indicate cepstrum coefficients obtained based on the cepstrum analysis.

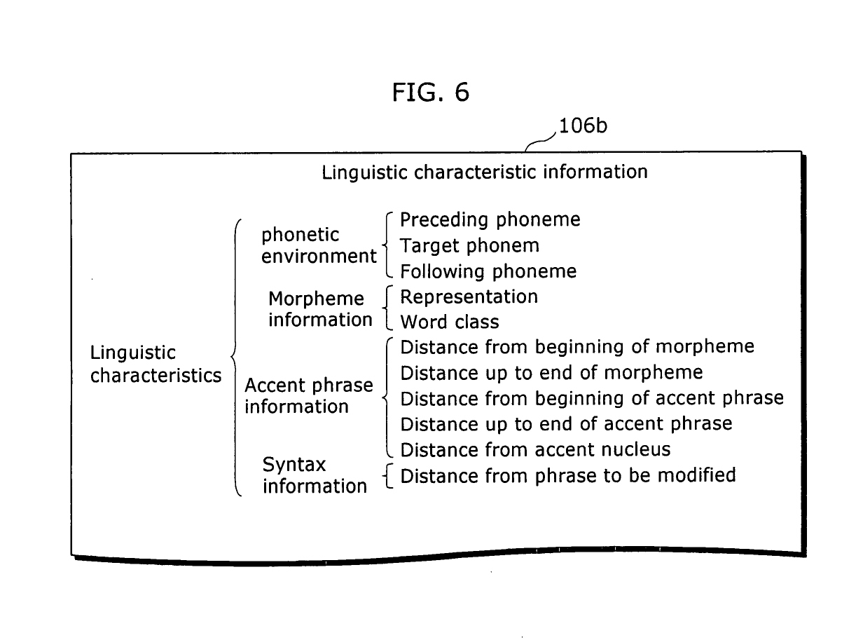

FIG. 6 is a diagram showing the contents of the linguistic characteristic information.

As shown in FIG. 6, the linguistic characteristic information 106b indicates, as linguistic characteristics, a phonetic environment, morpheme information, accent phrase information and syntax information. The phonetic environment indicates a current phoneme to be analyzed (target phoneme), a phoneme immediately preceding the target phoneme (preceding phoneme) and a phoneme immediately following the target phoneme (following phoneme). Note that this phonetic environment is the information which has been used conventionally. The morpheme information indicates the morpheme including the target phoneme. To be more specific, the morpheme information indicates the representation and the word class of the morpheme. The word class indicated by the morpheme information is subclassified (hierarchized) if necessary. If a word of the class declines (inflects), the declined form of the word is also indicated by the morpheme information. The accent phrase information is the information indicating the position of a target phoneme in an accent phrase. To be more specific, the accent phrase information indicates the distance from the beginning of the accent phrase, the distance to the end of the accent phrase and the distance from the accent nucleus. The syntax information indicates the modification relation of the phrase including the target phoneme.

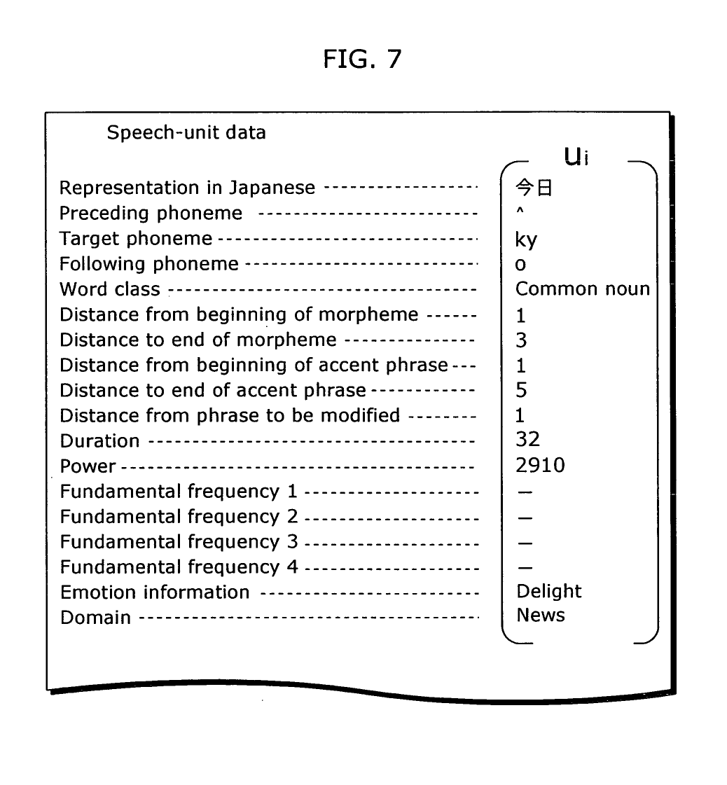

FIG. 7 is a diagram showing the contents of one speech-unit data stored in the characteristic parameter DB 106.

When a speech-unit is a phoneme, the characteristic parameter DB 106 holds speech-unit data representing the characteristics of each phoneme by a vector, as shown in FIG. 7. The speech-unit data includes the above-mentioned linguistic characteristic information 106b and the acoustic characteristic information 106a for the phoneme. For example, the speech-unit data indicates the characteristics of a phoneme uᵢ such as the representation in Japanese “ [symbol] ”, the phoneme “ky”, the word class “common noun” and the like. Note that the speech-unit data may indicate the emotion of the speaker who uttered the speech-unit and the domain to which the text that is the source of the speech-unit belongs.

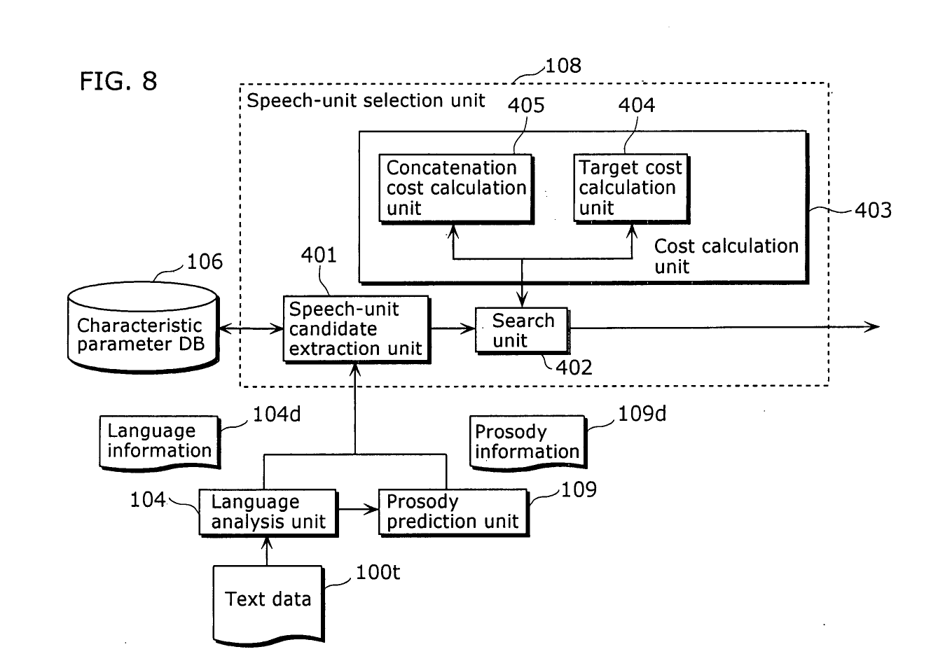

FIG. 8 is a block diagram showing one example of the structure of the speech-unit selection unit.

The speech-unit selection unit 108 includes a speech-unit candidate extraction unit 401 and a search unit 402 and a cost calculation unit 403.

The speech-unit candidate extraction unit 401 extracts, from the characteristic parameter DB 106, a set of speech-unit data which are potential candidates for the speech-unit data to be used for speech synthesis of each speech-unit (phoneme) indicated by the language information 104d transmitted from the language analysis unit 104, in consideration of the prosody information 109d transmitted from the prosody prediction unit 109. The search unit 402 searches for the speech-unit data which is most similar to the language information 104d transmitted from the language analysis unit 104 and the prosody information 109d transmitted from the prosody prediction unit 109, from among the candidates extracted by the speech-unit candidate extraction unit 401. Note that the search unit 402 searches for a series of speech-unit data which appear in time sequence corresponding to the phonetic representation of the language information 104d, all at once as a sequence of speech-units.

The cost calculation unit 403 calculates the cost that is the criterion for the search of the most similar sequence of speech-units by the search unit 402. This cost calculation unit 403 includes a target cost calculation unit 404 and a concatenation cost calculation unit 405.

The target cost calculation unit 404 calculates, as a cost (target cost), the matching between (i) the language information 104d and the prosody information 109d of each speech-unit (phoneme) indicated by the language information 104d and (ii) the linguistic characteristic information 106b and the acoustic characteristic information 106a of the candidates extracted by the speech-unit candidate extraction unit 401.

The cost calculation based on the linguistic characteristics indicated by the language information 104d and the linguistic characteristic information 106b is, to be more specific, the calculation based on the matching levels of a word class, a position in a morpheme, a position in an accent phrase, syntax information, a phonetic environment and a morpheme representation, respectively. The matching level of a word class is the matching level between the word class of a morpheme to which the phoneme indicated by the language information 104d belongs and the word class indicated by the linguistic characteristic information 106b. The matching level of a position in a morpheme is the matching level between the position of a phoneme in the morpheme indicated by the language information 104d and the position of the phoneme in the morpheme (such as the distance from the beginning of the morpheme and the distance to the end of the morpheme) indicated by the linguistic characteristic information 106b. The matching level of a position in an accent phrase is the matching level between the position of a phoneme in the accent phrase indicated by the language information 104d and the position of the phoneme in the accent phrase (such as the distance from the beginning of the accent phrase and the distance to the end of the accent phrase) indicated by the linguistic characteristic information 106b. The matching level of syntax information is the matching level between a phrase to be modified by a phrase including a phoneme indicated by the language information 104d and a phrase to be modified by a phrase indicated by the syntax information included in the linguistic characteristic information 106b. And the matching level of the a phonetic environment is the matching level between a phoneme and the preceding and following phonemes indicated by the language information 104d and a target phoneme and the preceding and following phonemes indicated by the linguistic characteristic information 106b.

Note that as shown in FIG. 4, it is possible to add a calculation of a matching level of a word class based on subclassified word classes so as to build a structure with higher accuracy.

The cost calculation based on the acoustic characteristics indicated by both the prosody information 109d and the acoustic characteristic information 106a is, to be more specific, the calculation based on the matching levels of a duration, fundamental frequency and power, respectively. The matching level of a duration is the matching level between the duration of a phoneme indicated by the prosody information 109d and the duration indicated by the acoustic characteristic information 106a. The matching level of a fundamental frequency is the matching level between the fundamental frequency of a phoneme indicated by the prosody information 109d and the fundamental frequency indicated by the acoustic characteristic information 106a. And the matching level of a power is the matching level between the power of a phoneme indicated by the prosody information 109d and the power indicated by the acoustic characteristic information 106a.

This target cost calculation unit 404 adds the cost calculated based on the linguistic characteristics as mentioned above and the cost calculated based on the acoustic characteristics so as to calculate the final cost (target cost).

The concatenation cost calculation unit 405 calculates, as a concatenation cost, the distortion which occurs when candidates are concatenated.

Here, the operations of the speech synthesis apparatus in the present embodiment as shown in FIG. 2 are described below in detail. Particularly, the operations performed when the text data 100t indicating the text “ [symbol] [symbol] ” as shown in FIG. 4 is inputted are described. Note that a phoneme is used as an example of a speech-unit in the following description, but the present invention does not limit a speech-unit to a phoneme.

First, the language analysis unit 104 represents the text indicated by the text data 100t phonetically, and splits the phonetic representation into morphemes. The language analysis unit 104 also analyzes the syntax (parses the text) so as to obtain the syntax information (information indicating phrases to be modified). Furthermore, the language analysis unit 104 assigns phonetic readings and accent phrases. As a result, the language information 104d as shown in FIG. 4 is generated.

The prosody prediction unit 109 predicts the duration, fundamental frequency and power of each phoneme based on the language information 104d shown in FIG. 4. As a result, the prosody information 109d is generated.

The speech-unit candidate extraction unit 401 of the speech-unit selection unit 108 builds a target vector tᵢ of each speech-unit (phoneme in this example) including, as components, the obtained language information 104d and prosody information 109d, as shown in the speech-unit data of FIG. 7 as represented in a vector. In this case, there is no information about the fundamental frequency because the phoneme “ky” is a voiceless corisonant. However, if a phoneme is a voiced sound, it is also possible to represent the dynamic characteristics of the fundamental frequency, as speech-unit data and a target vector tᵢ, by dividing the duration of the phoneme into four sections and representing the fundamental frequencies of the midpoints of respective sections by 4 points (fundamental frequencies 1 to 4). Note that the present invention is not limited to the representation of fundamental frequencies as mentioned above.

Next, the speech-unit candidate extraction unit 401 extracts a set of candidate speech-unit data from the characteristic parameter DB 106. To be more specific, the speech-unit candidate extraction unit 401 extracts all the speech-unit data indicating the same phonemes as the target phoneme indicated by the language information 104d.

Note that when sufficient amount of speech-unit data is stored in the characteristic parameter DB 106, the speech-unit candidate extraction unit 401 may obtain the candidates by adding a constraint of a phonetic environment (a preceding phoneme and a following phoneme).

The target cost calculation unit 404 calculates the matching level between a target vector tᵢ and a candidate uᵢ, as a target cost vector Cᵢ^{t}.

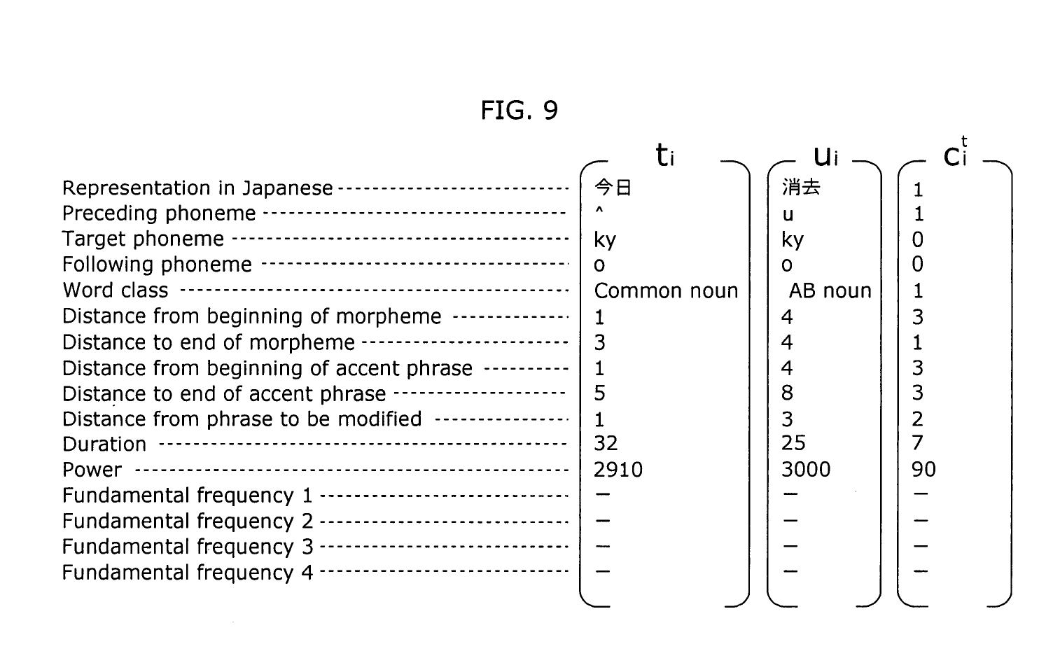

FIG. 9 is a diagram showing a target vector, a candidate and a target cost vector.

In the case where a candidate uᵢ and a target vactor tᵢ are given, for example, as shown in FIG. 9, the target cost calculation unit 404 calculates the matching level between them for each vector component and regards the calculation result as a target cost vector Cᵢ^{t}. The target cost calculation unit 404 calculates the target cost based on this target cost vector Cᵢ^{t}. In other words, the target cost calculation unit 404 calculates the target cost by assigning weights on sub-costs that are respective components shown in the target cost vector Cᵢ^{t} and adding them up.

The weights may be assigned to respective sub-costs based on empirical rules, but it is also possible to structure the target cost calculation unit 404 so as to determine them by the following method. For example, the target cost calculation unit 404 performs multiple regression analysis using a cost value calculated by each parameter and a distance from a target to a representative phoneme, and uses the coefficient of each cost value in a regression model as a weight. A cepstrum distance can be used for estimation of the distance from the target. Or, another weight such as an equal weight can also be used.

Note that weights may be assigned to sub-costs for linguistic characteristics in descending order (from heavier to lighter) from morpheme information, accent phrase information, and then syntax information. In other words, priorities for selecting speech-unit data are given in descending order from the matching levels of morpheme information, accent phrase information, and syntax information. It is also possible to assign weights to respective items of the accent phrase information, in the order, from heavier to lighter, from a distance from an accent nucleus, a distance to the end of the accent phrase, and a distance from the beginning of the accent phrase. In other words, priorities for selecting speech-unit data are given in descending order from the matching levels of a distance from an accent nucleus, a distance to the end of the accent phrase, and a distance from the beginning of the accent phrase.

In the example of FIG. 9, the target vector tᵢ “ [symbol] ” does not match the candidate uᵢ “ [symbol] ” as for Japanese representations, the target vector tᵢ “\hat{ } (the beginning of a sentence)” does not match the candidate uᵢ “u” as for preceding phonemes, the target vector tᵢ “o” matches the candidate uᵢ “o” for following phonemes, and the target vector tᵢ “common noun” does not match the candidate uᵢ “AB noun” as for word classes. As for non-numerical components, the target cost calculation unit 404 assigns “0” when both a target vector and a candidate matches and “1” when they do not match each other. On the other hand, as for numerical components, the target cost calculation unit 404 assigns an absolute value of a difference between the components as a sub-cost. Therefore, the sub-cost for the distance from the beginning of the morpheme is 4−1=3, the sub-cost for the distance to the end of the morpheme is 4−3=1, the sub-cost for the distance from the beginning of the accent phrase is 4−1=3, the sub-cost for the distance to the end of the accent phrase is 8−5=3, the sub cost for the duration is 32−25=7, and the sub-cost for the power is 3000−2910=90. The target cost calculation unit 404 calculates the total target cost by assigning the above weights on respective sub-costs by empirical rules and adding them up.

The concatenation cost calculation unit 405 calculates, as a concatenation cost, the distortion that occurs when two speech-unit data are concatenated. It may be calculated by any method, and for example, the concatenation cost calculation unit 405 regards the cepstrum distance between the two speech-unit data that are concatenation frames as the concatenation cost.

The search unit 402 selects the optimum speech-unit data using the target cost and the concatenation cost from among the candidates extracted by the speech-unit candidate extraction unit 401. To be more specific, the search unit 402 searches for the optimum sequence of speech-units based on the following equation 1.

$$C ( {t}_{i}^{n} , {u}_{1}^{n} ) = {\sum }_{i = 1}^{n} {C}^{t} ( {t}_{i} , {u}_{i} ) + {\sum }_{i = 2}^{n} {C}^{c} ( {u}_{i - 1} , {u}_{i} ) \qquad Equation 1$$

In the equation 1, “n” is the number of phonemes included in text (phonetic representation in the language information 104d). For example, the number “n” in the text “ [symbol] [symbol] ” is 21. “u” is speech-unit data as a candidate, “t” is a target vector, “C^{t}” is a target cost, and “C^{c}” is a concatenation cost.

The search unit 402 specifies the sequence of speech-units of which cost C is minimum as the whole text, and notifies it to the speech synthesis unit 110.

Next, the specific operations of the speech synthesis apparatus in the present embodiment when it obtains text data 100t including a loan word.

For example, the speech analysis unit 104 of the speech synthesis apparatus obtains Japanese text data 100t indicating “ [symbol] [symbol] ” (This is a ground). The word “ [symbol] ” (ground) in the above text is a loan word.

Upon receipt of the text data 100t, the language analysis unit 104 generates language information 104d based on the text data 100t.

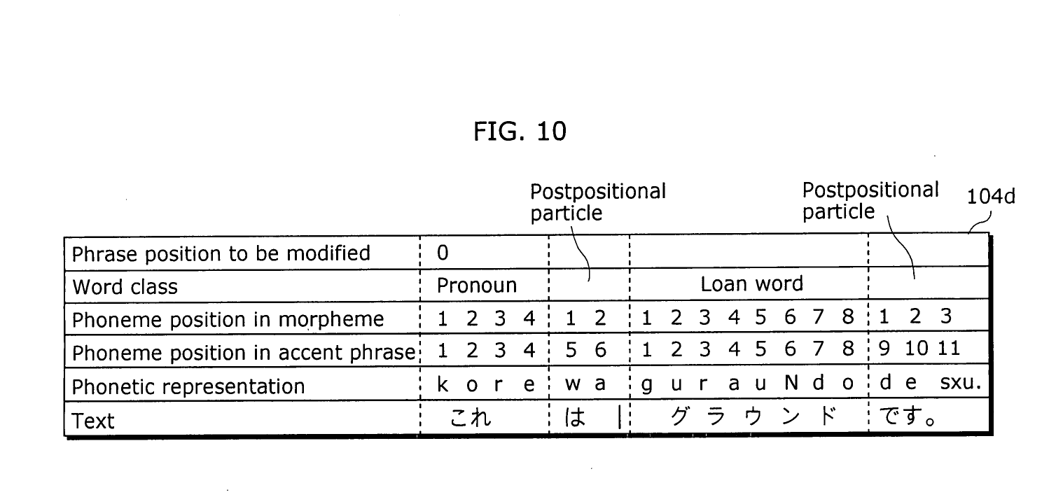

FIG. 10 is a diagram showing the contents of the language information 104d generated from the text data 100t indicating the loan word.

This language information 104d indicates, as is the case with the language information 104d in FIG. 4, text, a series of phonemes (phonetic representation) that corresponds to the text, respective morphemes included in the text, respective phrases included in the text, word classes of the morphemes, phoneme positions in respective morphemes, phoneme positions in respective accent phrases, and phrases to be modified. This language information 104d indicates that the word class of the morpheme “ [symbol] ” is a loan word.

The speech-unit selection unit 108 selects, from the characteristic parameter DB 106, the optimum speech-unit data for each phoneme indicated in the language information 104d.

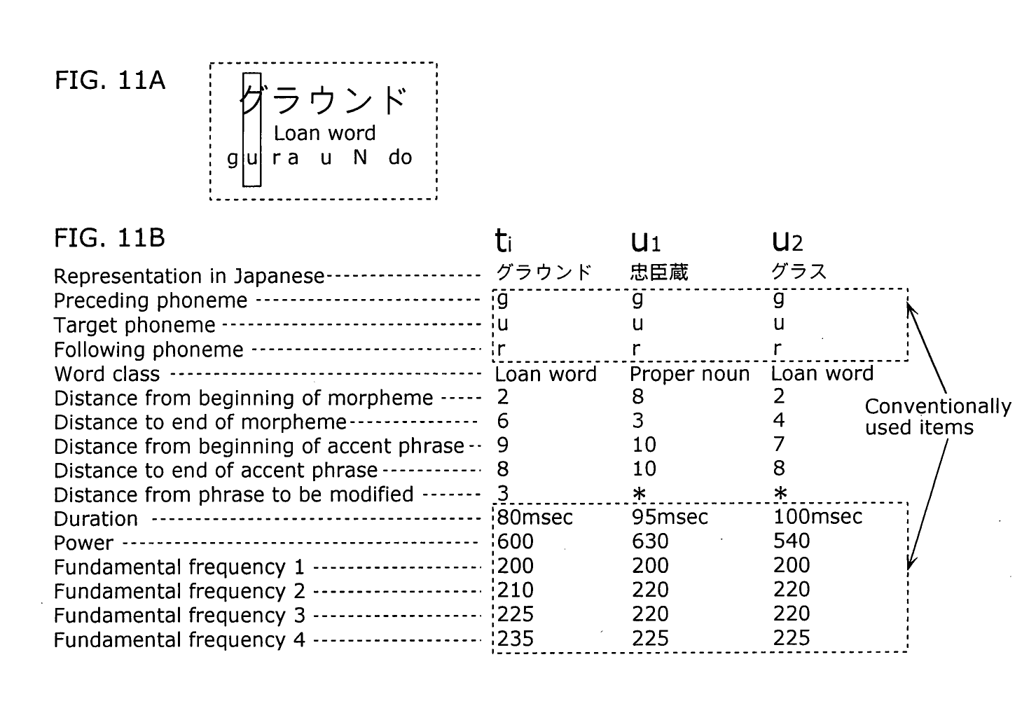

FIG. 11A is an illustration for explaining a target phoneme for which speech-unit data is to be selected.

For example, the speech-unit selection unit 108 selects the optimum speech-unit data for the phoneme “u” that is a vowel of “ [symbol] ” in the loan word “ [symbol] ”.

To be more specific, the speech-unit selection unit 108 first generates the target vector tᵢ for the phoneme “u” and selects candidates u₁ and u₂ that correspond to the phoneme “u” from the characteristic parameter DB 106.

FIG. 11B is a diagram showing the target vector tᵢ and the candidates u₁ and u₂ for the phoneme “u”. The word class of the Japanese representation of the candidate u₁ “ [symbol] ” is a proper noun. The word class of the representation of the candidate u₂ “ [symbol] [symbol] ” is a loan word and the representation “ [symbol] ” means “glass” in English.

The speech-unit selection unit 108 selects, as the optimum speech-unit data to be used for speech synthesis, the candidate which is closest to the target vector tᵢ from among the candidates u₁ and u₂.

Here, a conventional speech synthesis apparatus selects the candidate u₁ out of the candidates u₁ and u₂ using phonetic environments (a preceding phoneme, a target phoneme and a following phoneme) and acoustic characteristics (a duration, a power, a fundamental frequency and the like). The candidate u₁ is selected because it is closer to the target vector tᵢ than the candidate u₂ in the acoustic characteristics. However, there is a difference that cannot be expressed by the above-mentioned acoustic characteristics between the phoneme “u” included in a Japanese proper noun and the phoneme “u” included in a loan word. As a result, the conventional speech synthesis apparatus outputs unnatural synthesized speech because it selects inappropriate speech-unit data to be used for speech synthesis.

On the other hand, the speech synthesis apparatus in the present embodiment can select the optimum speech-unit data using the word class that is one of the linguistic characteristics. In more detail, if the word class of a target vector tᵢ is a loan word, the speech-unit selection unit 108 of the speech synthesis apparatus selects the candidate u₂ of which word class is a loan word, in consideration that the target vector tᵢ is a loan word. As a result, the speech synthesis apparatus in the present embodiment can convert the loan word indicated by the text data 100t into natural synthesis speech suitable for a loan word.

Next, the specific operations of the speech synthesis apparatus in the present embodiment when it obtains text data 100t indicating a final particle.

For example, the language analysis unit 104 of the speech synthesis apparatus obtains text data 100t indicating a Japanese text “ [symbol] [symbol] ” (this is a ground, isn't it?). The word class of “ [symbol] ” in the text is a final particle.

Upon receipt of the text data 100t, the language analysis unit 104 generates language information 104d based on the text data 100t.

The speech-unit selection unit 108 selects, from the characteristic parameter DB 106, the optimum speech-unit data for each phoneme indicated in the language information 104d.

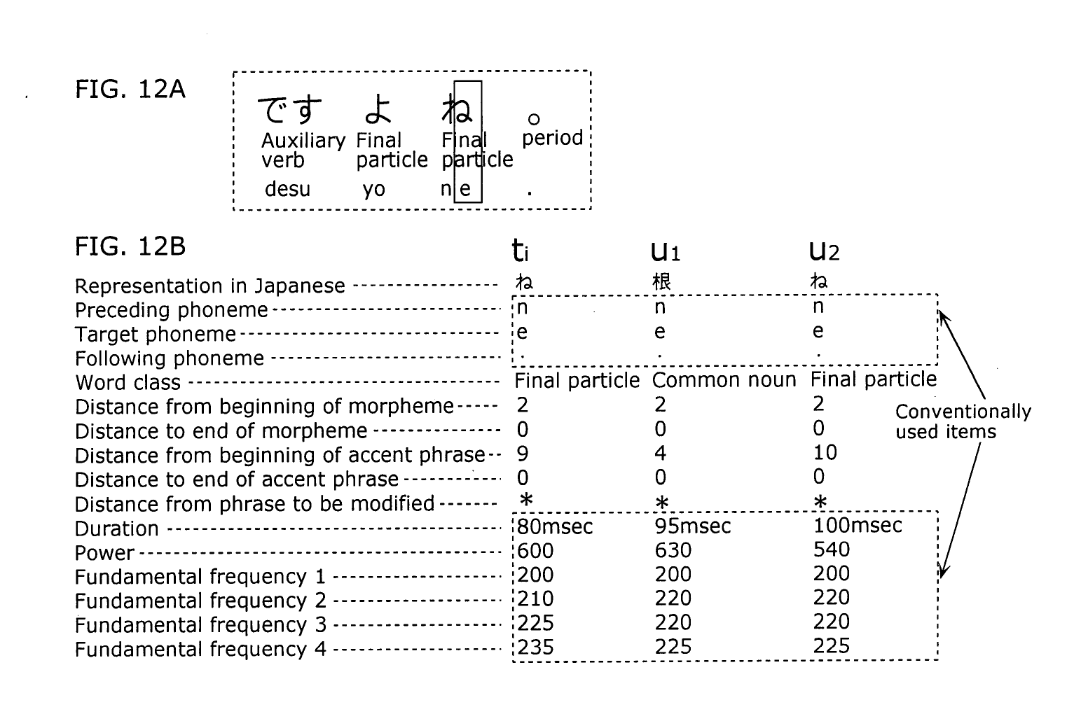

FIG. 12A is an illustration for explaining a target phoneme for which speech-unit data is to be selected.

For example, the speech-unit selection unit 108 selects the optimum speech-unit data for the phoneme “e” that is a vowel of the final particle “ [symbol] ”.

To be more specific, the speech-unit selection unit 108 first generates the target vector tᵢ for the phoneme “e” and selects candidates u₁ and u₂ that correspond to the phoneme “e” from the characteristic parameter DB 106.

FIG. 12B is a diagram showing the target vector tᵢ and the candidates u₁ and u₂ for the phoneme “e”. The word class of the candidate u₁ represented in Japanese “ [symbol] ” is a common noun and “ [symbol] ” means a “root” in English. The word class of the candidate u₂ “ [symbol] ” is a final particle.

The speech-unit selection unit 108 selects, as the optimum speech-unit data to be used for speech synthesis, the candidate which is closest to the target vector tᵢ from among the candidates u₁ and u₂.

Here, a conventional speech synthesis apparatus selects the candidate u₁ out of the candidates u₁ and u₂ using phonetic environments (a preceding phoneme, a target phoneme and a following phoneme) and acoustic characteristics (a duration, a power, a fundamental frequency and the like). The candidate u₁ is selected because it is closer to the target vector tᵢ than the candidate u₂ in the acoustic characteristics. However, the phoneme “e” included in a Japanese final particle “ [symbol] ” has a specific characteristic, which is quite different from the characteristic of the phoneme “e” included in “ [symbol] ” of another word class. Therefore, the speech-unit data selected by the conventional speech synthesis apparatus is likely to match the target vector tᵢ in acoustic characteristics, but it may not always be appropriate as speech-unit data to be used for actual synthesized speech.

On the other hand, the speech synthesis apparatus in the present embodiment can select the optimum speech-unit data using the word class that is one of the linguistic characteristics. In more detail, if the word class of the target vector tᵢ is a final particle, the speech-unit selection unit 108 of the speech synthesis apparatus selects the candidate u₂ of which word class is a final particle, in consideration that the target vector tᵢ is a final particle if it is. As a result, the speech synthesis apparatus in the present embodiment can convert the final particle indicated by the text data 100t into natural synthesis speech suitable for expressing a nuance such as a feeling of questioning indicated by the final particle.

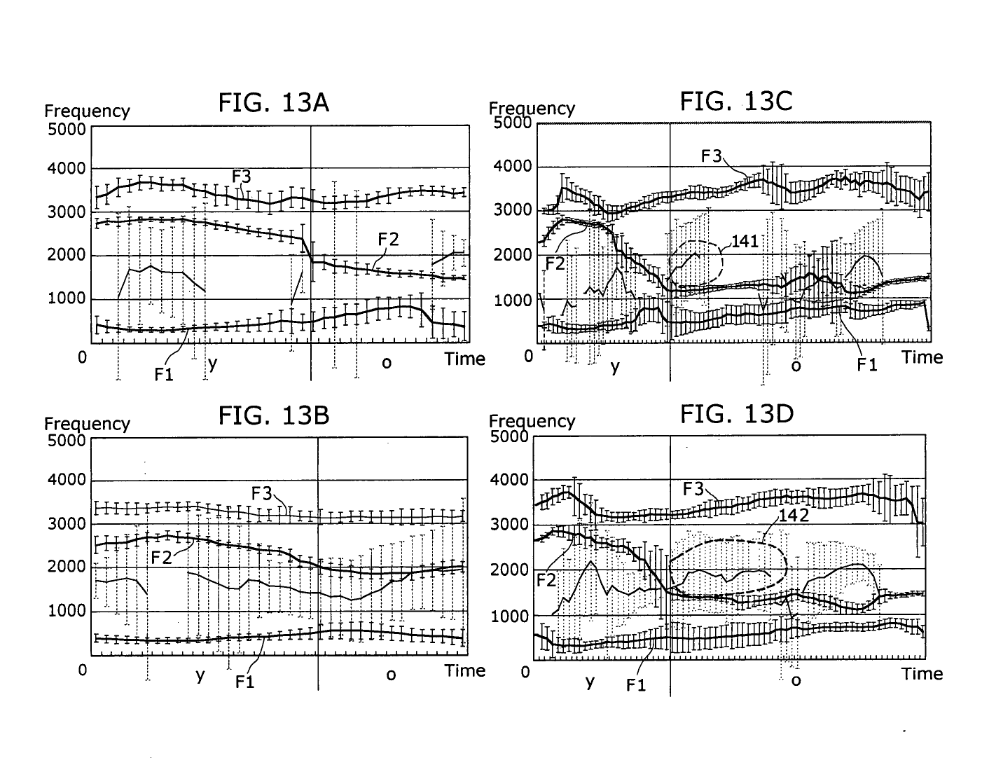

FIG. 13A, FIG. 13B, FIG. 13C and FIG. 13D are illustrations for explaining the effects of the present invention. These diagrams show the results of the analysis of phonetic segments of a phone “ [symbol] ” (“yo” if represented by phonemes) which belongs to four different words, according to the document “Ohtsuka, Kasuya, “An improved Speech Analysis-Synthesis Algorithm based on the Autoregressive with Exogenous Input Speech Production Model”, ICSLP2000”. In this analysis, an audio signal is separated into a vocal cord (sound source) and a vocal tract (filter) by applying the audio signal to a speech generation model.

FIG. 13A shows a result of analyzing a phone “ [symbol] ” (yo) in an Japanese adverb “ [symbol] <” (“fully” in English). FIG. 13B shows a result of analyzing a phone “ [symbol] ” in a Japanese common noun “ [symbol] ” (“night” in English). FIG. 13C shows a result of analyzing a phone “ [symbol] ” that is a Japanese final particle included in one sentence. FIG. 13D shows a result of analyzing a phone “ [symbol] ” that is a Japanese final particle included in another sentence.

These analysis results show the center frequency F1 in the first formant, the center frequency F2 in the second formant, the center frequency F3 in the third formant and the bandwidths of respective formants. Note that in these diagrams, the bandwidths are represented by vertical line segments overlapped on the lines indicating the center frequencies F1, F2 and F3 respectively. The above-mentioned center frequency in each formant indicates the peak generated by vocal tract resonance, while the bandwidth indicates resonance intensity. Wider bandwidth means weaker resonance, while narrower bandwidth means more intense resonance.

All of the four analysis results in these diagrams show the common characteristic of the phone “ [symbol] ”, that is, the center frequency F1 of the first formant goes up and the center frequency F2 of the second formant goes down from the first half to the second half of the time axis. Therefore, regardless of the word class of the morpheme including the phone “ [symbol] ”, the locus of the center frequency (hereinafter referred to as a “formant locus”) of each formant for the phone “ [symbol] ” is similar to each other.

As described above, the formant loci of the phone “ [symbol] ” t included in various morphemes have the common characteristic, but the sound of the phone “ [symbol] ” perceived by ear varies widely among the word classes of the morphemes including these phone “ [symbol] ”. Humans have the impression that respective phones “ [symbol] ” of final particles as shown in FIG. 13C and FIG. 13D are similar to each other. On the other hand, they have the impression that the phone “ [symbol] ” of the final particle as shown in FIG. 13C and the phone “ [symbol] ” included in the adverb morpheme as shown in FIG. 13A are different from each other. Similarly, they have the impression that the phone “ [symbol] ” of the final particle as shown in FIG. 13C and the phone “ [symbol] ” of the common noun morpheme as shown in FIG. 13B are different from each other.

Only the formant locus cannot explain such a variety of impressions.

Since a final particle is uttered in a relaxed state at the end of a sentence, a speaker's vocal cord tends to close loosely while vibrating. It has been well known that the influence of resonance in the space below the vocal cord such as a trachea and lungs (hereinafter referred to as “subglottic space”) appears strongly in a wide glottis (space between folds on both sides of the vocal cord) like this. This is described in the document written by D. Klatt and L. Klatt (See “Analysis, Synthesis, and Perception of Voice Quality Variations among Female and Male talkers”, J. Acoust. Soc. Am. 87(2), February 1990, pp. 820-857).

According to “D. Results III: Tracheal coupling” (p. 832) of the above document, the resonance in the subglottic space produces the following phenomena: pole-zero appearance and wider bandwidth in the first formant. The analysis result of FIG. 13C shows appearance of a weak peak 141 of frequencies different from those of the formant. Similarly, in the analysis result of FIG. 13D, a weak peak 142 of frequencies different from those of the formant appears. Since the above document describes that the pole appears in the vicinity of 1700 Hz in the case of a female voice, it seems that the peaks 141 and 142 are the appearance of the poles as described in the above document. In addition, the analysis results of FIG. 13C and FIG. 13D show the common characteristic that the bandwidths of the first formants in these diagrams are relatively wide.

On the other hand, the analysis results of FIG. 13A and FIG. 13B do not clearly show the above-mentioned two phenomena.

As described above, the impressions that humans have when they hear phones greatly depend on the word classes to which respective phones belong to, even if the acoustic characteristics indicated by their formant loci resemble each other. Particularly, the impressions greatly depend on whether the word class of each phone is a final particle or a loan word.

So, the speech synthesis apparatus in the present embodiment can output natural synthesized speech because it selects speech-unit data appropriate for a word class (particularly, a final particle or a loan word) of a morpheme including phonemes. In other words, the speech synthesis apparatus in the present embodiment can output natural synthesized speech just as text of text data 100t indicates.

In addition, the speech synthesis apparatus in the present embodiment selects speech-unit data in consideration of not only acoustic characteristics but also linguistic characteristics such as whether or not a word is a loan word or a final particle. Therefore, it becomes possible to select speech-unit data with a higher confidence level based on the linguistic characteristics of the speech-unit data stored in the characteristic parameter DB 106, even if the prosody prediction unit 109 cannot predict the acoustic characteristics accurately enough.

Furthermore, the speech synthesis apparatus according to the present invention is of value as a reading-out apparatus or the like in the fields of car navigation systems and entertainment.

(First Modification)

The speech synthesis unit 110 in the first embodiment generates a synthesized speech signal based on a series of speech-unit data held in the characteristic parameter DB 106. On the other hand, the speech synthesis unit according to the present modification generates a synthesized speech signal by obtaining signals indicating speech waveforms that correspond to respective speech-unit data and concatenating them.

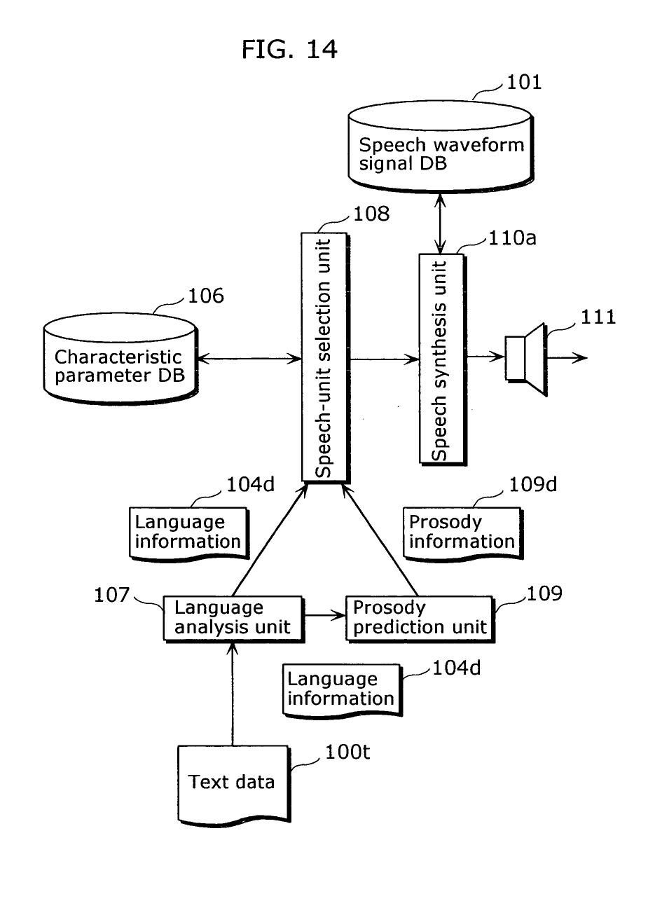

FIG. 14 is a block diagram showing the structure of the speech synthesis apparatus according to the first modification of the first embodiment.

The speech synthesis apparatus in the present modification includes a characteristic parameter DB 106, a language analysis unit 104, a prosody prediction unit 109, a speech-unit selection unit 108, a speech synthesis unit 110a, a speaker 111 and a speech waveform signal DB 101.

The speech waveform signal DB 101 holds speech waveform signals indicating speech waveforms that correspond to respective speech-unit data stored in the characteristic parameter DB 106.

The speech synthesis unit 110a specifies the sequence of speech-unit data selected by the speech-unit selection unit 108, and obtains the speech waveform signals that correspond to respective speech-unit data from the speech waveform signal DB 101. Then, the speech synthesis unit 110a generates a synthesized speech signal by concatenating these speech waveform signals.

(Second Modification)

The cost calculation unit 403 in the first embodiment calculates a target cost by assigning predetermined weights to respective sub-costs and adding them up. On the other hand, the cost calculation unit according to the present modification has a feature of changing the weights to be assigned.

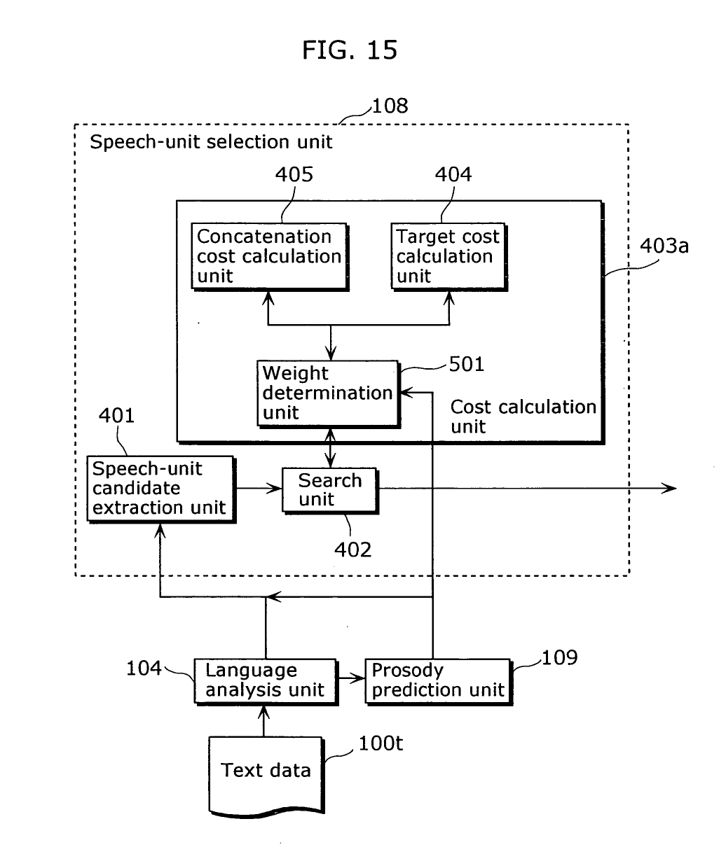

FIG. 15 is a block diagram showing the internal structure of the cost calculation unit according to the second modification of the first embodiment.

A cost calculation unit 403a according to the present modification includes a target cost calculation unit 404, a concatenation cost calculation unit 405 and a weight determination unit 501.

When the target cost calculation unit 404 calculates costs, the weight determination unit 501 changes the weights of linguistic characteristics and the weights of acoustic characteristics based on the confidence level of the prosody information 109d outputted from the prosody prediction unit 109. Then, the weight determination unit 501 notifies the target cost calculation unit 404 of the changed weights. The target cost calculation unit 404 calculates the target cost based on the weights notified by the weight determination unit 501.

For example, in the case where the confidence level of the prosody information 109d is low, the weight determination unit 501 assigns heavier weights on the sub-costs of linguistic characteristics, while assigns lighter weights on the sub-costs of acoustic characteristics. As a result, the target cost calculation unit 404 calculates the target cost based on the matching levels of linguistic characteristics rather than those of acoustic characteristics. Then, the search unit 402 selects speech-unit data in consideration of the matching levels of linguistic characteristics rather than the matching levels of acoustic characteristics. In other words, if a target vector tᵢ does not match a candidate in linguistic characteristics although it matches in acoustic characteristics, the search unit 402 does not select the candidate but selects another candidate that matches in linguistic characteristics.

As described above, the cost calculation unit 403a according to the present modification changes weights to be assigned to sub-costs depending on the confidence level of the prosody information 109d that is a prediction result by the prosody prediction unit 109. Therefore, even in the case where it is difficult for the prosody prediction unit 109 to predict a speaker's emotions and the like, it becomes possible to select very reliable speech-unit data not by depending on the direct prediction results such as fundamental frequencies, durations and powers but by placing prime importance on matching levels in linguistic characteristics.

For example, the prosody prediction unit 109 obtains language information 104d indicating a loan word as shown in FIG. 10 and generates prosody information 109d based on the language information 104d. In this case, the weight determination unit 501 judges that the confidence level of the prosody information 109d is low, and assigns heavier weight on the sub-cost that corresponds to the word class of the loan word, for example. As a result, the appropriate speech-unit data is selected and then more natural synthesized speech can be outputted. In addition, when matching levels of characteristics of respective phonemes are evaluated, it is possible to consider not only the full matching thereof but also the matching levels of characteristics of respective groups of phonemes. Thereby, it becomes possible to respond flexibly to subtle differences (deviations) in phonetic representations in Japanese such as “ [symbol] ” and “ [symbol] ”.

(Third Modification)

Here is a description of a modification concerning a method for selecting speech-unit data in the present embodiment.

The speech-unit selection unit 108 in the first embodiment selects speech-unit data by considering linguistic and acoustic characteristics at the same time. The speech-unit selection unit in the present modification selects speech-unit data by considering linguistic characteristics preferentially.

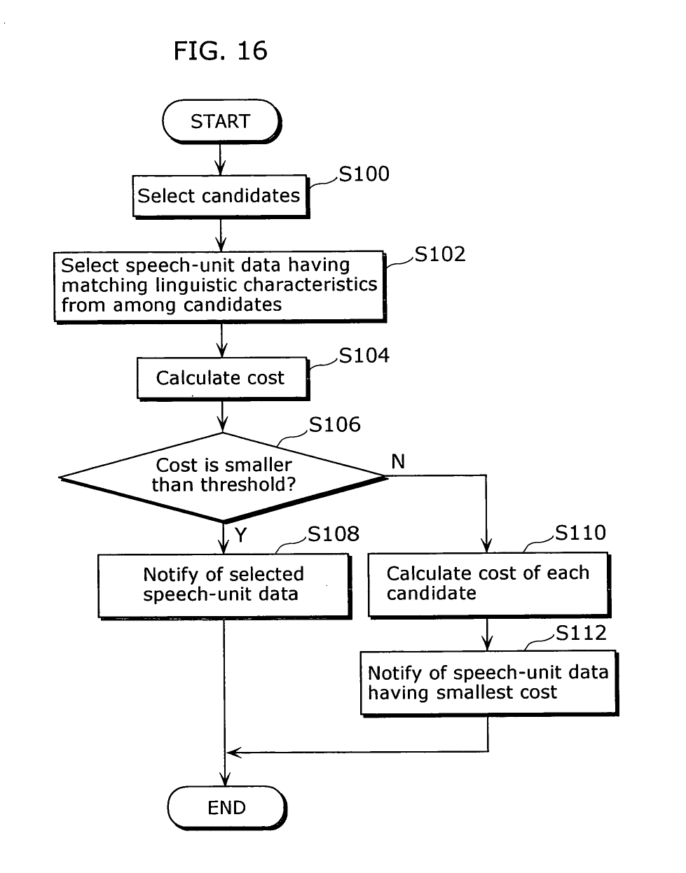

FIG. 16 is a flowchart showing operations of the speech-unit selection unit in the third modification.

First, the speech-unit selection unit selects candidate speech-unit data from the characteristic parameter DB 106 (Step S100).

Next, the speech-unit selection unit further selects, from among the candidates selected in Step S100, the speech-unit data of which linguistic characteristics match those of the speech-unit indicated in the language information 104d (Step S102). Then, the speech-unit selection unit calculates the cost of the selected speech-unit data (Step S104).

Here, the speech-unit selection unit judges whether or not the value of the calculated cost is smaller than a threshold (Step S106). When it judges that the calculated cost is smaller than the threshold (Y in Step S106), the speech-unit selection unit notifies the speech synthesis unit 110 of the speech-unit selected in Step S102 (Step S108). On the other hand, when it judges that the calculated cost is the threshold or larger (N in Step S106), the speech-unit selection unit calculates the costs of respective candidates selected in Step S100 in the same manner as the first embodiment (Step S110). Then, the speech-unit selection unit notifies the speech synthesis unit 110 of the candidate speech-unit data of which cost is smallest (Step S112).

### Second Embodiment

Here is a description of a data creation apparatus that creates speech-unit data used in the first embodiment.

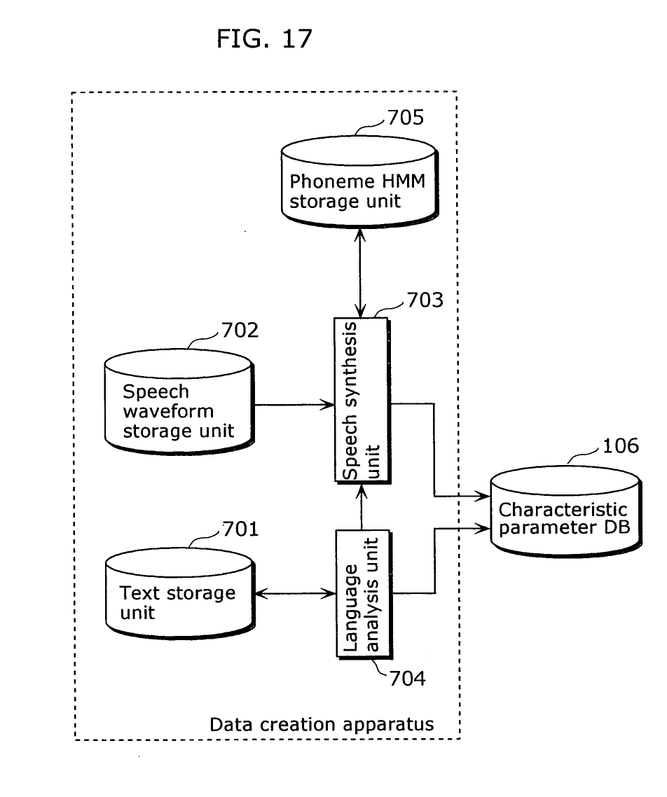

FIG. 17 is a block diagram showing the overall structure of the data creation apparatus in a second embodiment of the present invention.

The data creation apparatus creates speech-unit data to be stored in the characteristic parameter DB 106 of the speech synthesis apparatus, and includes a text storage unit 701, a speech waveform storage unit 702, a speech analysis unit 703, and a language analysis unit 704.

The speech waveform storage unit 702 is a database for storing speech waveform signals indicating recorded speech in waveforms. The text storage unit 701 stores transcripts of the recorded speech as text data. In other words, the contents indicated by a speech waveform signal are identical to the contents indicated by text data. The phoneme HMM storage unit 705 stores phoneme HMMs created for respective phonemes.

The language analysis unit 704 linguistically analyzes text indicated by the text data stored in the text storage unit so as to extract linguistic characteristics of each speech-unit (for example, a phoneme) from the text. Here, the linguistic characteristics are phonetic environments, morpheme information, syntax information, accent phrases and so on. The language analysis unit 704 stores the linguistic characteristic information indicating the linguistic characteristics of each speech-unit into the characteristic parameter DB 106 of the speech synthesis apparatus, and at the same time, outputs it to the speech analysis unit 703.

The speech analysis unit 703 obtains the linguistic characteristic information outputted from the language analysis unit 704, and at the same time, obtains the speech waveform signal that corresponds to the above text from the speech waveform storage unit 702. Then, the speech analysis unit 703 divides the obtained speech waveform signal into phonemes according to the phonetic representations indicated in the obtained linguistic characteristic information. Here, the speech analysis unit 703 uses the phoneme HMMs stored in the phoneme HMM storage unit 705 when dividing the speech waveform signal into phonemes. The speech analysis unit 703 further extracts the acoustic characteristics of each phoneme from the divided speech waveform signal. Here, the acoustic characteristics include a fundamental frequency, a duration, a cepstrum and the like. The acoustic characteristics may include an emotion that a speaker has when he/she utters the text.

The speech analysis unit 703 generates the acoustic characteristic information indicating the acoustic characteristics of each phoneme, and stores them into the characteristic parameter DB 106 of the speech synthesis apparatus.

The operations of the data creation apparatus in the present embodiment are described below. Here is a description of procedures by which the data creation apparatus adds the speech-unit data of text “ [symbol] [symbol] ” to the characteristic parameter DB 106.

First, the language analysis unit 704 reads text data from the text storage unit 701, and analyzes not only the morphemes and syntax of the text indicated in the text data but also the domains, phonetic readings and emotions thereof. For example, the language analysis unit 704 generates, as the analysis results, linguistic characteristic information indicating the same contents as the language information 104d shown in FIG. 4, and stores it into the characteristic parameter DB 106.

Next, the speech analysis unit 703 obtains, from the speech waveform storage unit 702, the speech waveform signal that corresponds to the text “ [symbol] [symbol] ”, and obtains the linguistic characteristic information from the language analysis unit 704. The speech analysis unit 703 segments the speech waveform signal into phonemes using a phoneme HMMs stored in the phoneme HMM storage unit 705 based on the phonetic representations indicated in the linguistic characteristic information. Although the speech-unit shall be a phoneme in this example, the present invention is not limited particularly to a phoneme.

After segmenting the speech waveform signal into phonemes, the speech analysis unit 703 analyzes the fundamental frequency, duration and power of each phoneme. The analysis method is not limited to a particular one, and any method can be used. The speech analysis unit 703 stores the analysis results, as acoustic characteristic information, into the characteristic parameter DB 106.

Note that the speech analysis unit 703, as a substitute for the language analysis unit 104, may analyze emotions and add the analysis results to acoustic characteristic information. In addition, if a speech waveform signal previously includes information indicating emotions, such information may be added to linguistic characteristic information or acoustic characteristic information.

As a result of the above operations, the data creation apparatus creates, in the characteristic parameter DB 106, speech-unit data represented by a vector per phoneme, as shown in FIG. 7. In the case of the text “ [symbol] [symbol] ”, the speech-unit data represented by 21 vectors is created.

As described above, according to the present embodiment, it becomes possible to easily formulate, in the characteristic parameter DB 106, speech-unit data including both linguistic characteristic information and acoustic characteristic information of each phoneme.

Although only some exemplary embodiments and modifications of the present invention have been described in detail above, the present invention is not limited to these embodiments and modifications.

For example, although text written in Japanese is converted into speech in the first and second embodiments, the present invention also allows conversion of text written in any other language into speech. The present invention is very effective particularly for text written in a language having loan words and final particles.

Furthermore, although a phoneme is handled as a speech-unit in the first and second embodiments, any other unit may be handled as a speech-unit.

1. A speech synthesis apparatus that obtains text data and converts text indicated by the text data into speech, comprising:
a storage unit operable to previously store, with respect to each speech-unit, speech-unit data that represents (i) a loan word attribute indicating whether or not a speech-unit belongs to a class of loan words and (ii) an acoustic characteristic of the speech-unit;
a characteristic prediction unit operable to obtain text data and predict, with respect to each of a plurality of speech-units that form text indicated by the text data, a loan word attribute and an acoustic characteristic;
a selection unit operable to select speech-unit data that represents a loan word attribute and an acoustic characteristic similar to the loan word attribute and the acoustic characteristic of each speech-unit predicted by the characteristic prediction unit, from among the speech-unit data stored in the storage unit; and
a speech output unit operable to generate synthesized speech using a plurality of the speech-unit data selected by the selection unit and output the synthesized speech.

2. The speech synthesis apparatus according to claim 1,
wherein when the characteristic prediction unit predicts the loan word attribute indicating that a speech-unit belongs to the class of loan words, the selection unit preferentially selects speech-unit data that represents the loan word attribute indicating that a speech-unit belongs to the class of loan words.

3. The speech synthesis apparatus according to claim 1,
wherein each speech-unit data further represents a final particle attribute indicating whether or not the speech-unit belongs to a class of final particles,
the characteristic prediction unit predicts, with respect to each of a plurality of speech-units that form the text indicated by the text data, the loan word attribute, the acoustic characteristic and a final particle attribute, and
the selection unit selects speech-unit data that represents a loan word attribute, an acoustic characteristic and a final particle attribute similar to the loan word attribute, the acoustic characteristic and the final particle attribute of the speech-unit predicted by the characteristic prediction unit, from among the speech-unit data stored in the storage unit.

4. The speech synthesis apparatus according to claim 3,
wherein when the characteristic prediction unit predicts the final particle attribute indicating that the speech-unit belongs to the class of final particles, the selection unit preferentially selects speech-unit data that represents the final particle attribute indicating that a speech-unit belongs to the class of final particles.

5. The speech synthesis apparatus according to claim 3,
wherein the acoustic characteristic indicates at least one of a duration, a fundamental frequency and a power of a speech-unit.

6. The speech synthesis apparatus according to claim 5,
wherein each speech-unit data further represents a phonetic environment to which the speech-unit belong to, syntax information relating to a syntax of the speech-unit and accent phrase information relating to an accent phrase of the speech-unit,
the characteristic prediction unit predicts, with respect to each of a plurality of speech-units that form the text indicated by the text data, the loan word attribute, the acoustic characteristic, the final particle attribute, phonetic environment, syntax information and accent phrase information, and
the selection unit selects speech-unit data that represents a loan word attribute, an acoustic characteristic, a final particle attribute, a phonetic environment, syntax information and accent phrase information similar to the loan word attribute, the acoustic characteristic, the final particle attribute, the phonetic environment, the syntax information and the accent phrase information of the speech-unit predicted by the characteristic prediction unit, from among the speech-unit data stored in the storage unit.

7. The speech synthesis apparatus according to claim 1,
wherein the selection unit includes:
a first calculation unit operable to calculate a first sub-cost by quantitatively evaluating a similarity level between the loan word attribute of the speech-unit predicted by the characteristic prediction unit and the loan word attribute of the speech-unit data stored in the storage unit;
a second calculation unit operable to calculate a second sub-cost by quantitatively evaluating a similarity level between the acoustic characteristic of the speech-unit predicted by the characteristic prediction unit and the acoustic characteristic of the speech-unit data stored in the storage unit;
a cost calculation unit operable to calculate a cost using the first and second sub-costs calculated by the first and second calculation units; and
a data selection unit operable to select speech-unit data from among the speech-unit data stored in the storage unit, based on the cost calculated by the cost calculation unit.

8. The speech synthesis apparatus according to claim 7,
wherein the cost calculation unit calculates the cost by assigning weights to the first and second sub-costs calculated by the first and second calculation units and adding up the weighted first and second sub-costs.

9. The speech synthesis apparatus according to claim 8, further comprising
a weight determination unit operable to specify a confidence level of the acoustic characteristic predicted by the characteristic prediction unit and determine the weights to be assigned to the first and second sub-costs depending on the confidence level, and
the cost calculation unit assigns the weights determined by the weight determination unit to the first and second sub-costs.

10. The speech synthesis apparatus according to claim 9,
wherein when the confidence level of the acoustic characteristic is low, the weight determination unit determines the weights to be assigned to the first and second sub-costs so that the similarity level between the loan word attributes is more influential in the selection of the speech-unit data by the data selection unit than the similarity level between the acoustic characteristics.

11. The speech synthesis apparatus according to claim 10,
wherein the selection unit further include
a third calculation unit operable to calculate a concatenation cost by quantitatively evaluating an acoustic distortion that occurs when a plurality of speech-unit data stored in the storage unit are concatenated, and
the cost calculation unit calculates the cost using the first and second sub-costs calculated by the first and second calculation units and the concatenation cost calculated by the third calculation unit.

12. A speech synthesis method for obtaining text data and converting text indicated by the text data into speech using data stored in a storage unit,
wherein the storage unit previously stores, with respect to each speech-unit, speech-unit data that represents (i) a loan word attribute indicating whether or not a speech-unit belongs to a class of loan words and (ii) an acoustic characteristic of the speech-unit, and
the method comprises:
obtaining text data and predicting, with respect to each of a plurality of speech-units that form text indicated by the text data, a loan word attribute and an acoustic characteristic of the speech-unit;
selecting speech-unit data that represents a loan word attribute and an acoustic characteristic similar to the predicted loan word attribute and acoustic characteristic of each speech-unit, from among the speech-unit data stored in the storage unit; and
generating synthesized speech using a plurality of the selected speech-unit data and outputting the synthesized speech.

13. The speech synthesis method according to claim 12,
wherein each speech-unit data further represents a final particle attribute indicating whether or not the speech-unit belongs to a class of final particles,
in the predicting, the loan word attribute, the acoustic characteristic and a final particle attribute are predicted with respect to each of a plurality of speech-units that form the text indicated by the text data, and
in the selecting, speech-unit data that represents a loan word attribute, an acoustic characteristic and a final particle attribute similar to the predicted loan word attribute, acoustic characteristic and final particle attribute is selected from among the speech-unit data stored in the storage unit.

14. A program for obtaining text data and converting text indicated by the text data into speech using data stored in a storage unit,
wherein the storage unit previously stores, with respect to each speech-unit, speech-unit data that represents (i) a loan word attribute indicating whether or not a speech-unit belongs to a class of loan words and (ii) an acoustic characteristic of the speech-unit, and
the program causes a computer to execute:
obtaining text data and predicting, with respect to each of a plurality of speech-units that form text indicated by the text data, a loan word attribute and an acoustic characteristic of the speech-unit;
selecting speech-unit data a loan word attribute and an acoustic characteristic similar to the predicted loan word attribute and acoustic characteristic of each speech-unit, from among the speech-unit data stored in the storage unit; and
generating synthesized speech using a plurality of the selected speech-unit data and outputting the synthesized speech.

15. A data creation apparatus that creates speech-unit data to be used for speech synthesis, comprising:
a speech storage unit operable to store a speech waveform signal that represents speech in a waveform;
a text storage unit operable to store text data indicating text that corresponds to the speech represented by the speech waveform signal;
a language analysis unit operable to obtain text data from the text storage unit, divide text indicated by the text data into speech-units, and analyze a loan word attribute of each speech-unit indicating whether or not the speech-unit belongs to a class of loan words;
an acoustic analysis unit operable to obtain a speech waveform signal from the speech storage unit, divide the speech represented by the speech waveform signal into speech-units, and analyze an acoustic characteristic of each speech-unit; and
a creation unit operable to create speech-unit data of each speech-unit so that said speech-unit data indicates the loan word attribute as analyzed by the language analysis unit and the acoustic characteristic as analyzed by the acoustic analysis unit, and store the created speech-unit data into a memory.

16. The data creation apparatus according to claim 15,
wherein the language analysis unit further analyzes a final particle attribute indicating whether or not each speech-unit belongs to a class of final particles, and
the creation unit creates the speech-unit data of each speech data so that said speech-unit data indicates the loan word attribute and the final particle attribute as analyzed by the language analysis unit and the acoustic characteristic as analyzed by the acoustic analysis unit.

17. The data creation apparatus according to claim 16,
wherein the acoustic characteristic indicates at least one of a duration, a fundamental frequency and a power of a speech-unit.

18. A data creation method for creating speech-unit data to be used for speech synthesis using data stored in a storage unit,
wherein the storage unit previously stores a speech waveform signal that represents speech in a waveform and text data indicating text that corresponds to the speech represented by the speech waveform signal, and
the method comprises:
obtaining text data from the text storage unit, dividing text indicated by the text data into speech-units, and analyzing a loan word attribute of each speech-unit indicating whether or not the speech-unit belongs to a class of loan words;
obtaining a speech waveform signal from the speech storage unit, dividing the speech represented by the speech waveform signal into speech-units, and analyzing an acoustic characteristic of each speech-unit; and
creating speech-unit data of each speech-unit so that said speech-unit data indicates the analyzed loan word attribute and acoustic characteristic, and storing the created speech-unit data into a memory.
